(19) United States
(12) Patent Application Publication
(10) Pub. No.: US 2007/0134614 A1
(43) Pub. Date: Jun. 14, 2007

(54) Device for illuminating tooth surfaces and human skin

(75) Inventors: Otto Weichselbaum, Liebenau (AT); Stefan Mina, Wiener Neustadt (AT); Miroslav Sili, Bad Voslau (AT); Johann Krocza, Vienna (AT)

Correspondence Address: LERNER GREENBERG STEMER LLP, P O BOX 2480, HOLLYWOOD, FL, 33022-2480, US

(73) Assignee: ARC Seibersdorf Research GmbH, Wien (AT)

(21) Appl. No.: 10/594,408

(22) PCT Filed: Mar. 8, 2005
(86) PCT No.: PCT/AT05/00078

§ 371 Date: Dec. 12, 2006

(30) Foreign Application Priority Data
Mar. 26, 2004 (AT) A 550/2004

(51) Int. Cl. A61C 3/00

(52) U.S. Cl. 433/29; 396/16; 348/66

(57) ABSTRACT

An attachment for or on an illuminating device of preferably uneven surfaces, in particular tooth surfaces, and/or for a or on a detection unit, in particular an intraoral camera. The illuminating device and/or the detection unit have at least one light source. The attachment includes a solid, transparent, preferably homogeneous, colorless and/or optically clear conductor having an, in particular, essentially flat light-admission surface and a light-exit surface, and a transparent, preferably homogeneous, colorless and/or optically clear pad adjoining the conductor or the light-exit surface of the conductor in a form-locking and optionally material-locking manner.

The invention relates to an attachment according to the preamble of claim 1.

Illuminating devices for, in particular, uneven surfaces, e.g. the surfaces of teeth, are known. Aside from the mere illumination of tooth surfaces, among other things, illuminating devices of this type are used to support or enable the use of detection instruments, e.g. image recording, image generating or image transmitting units. With the aid of detection devices of this type, surface properties, for example the colour, can be measured.
Thus, for example, when the colour of teeth is measured, the respective tooth is illuminated and an electronic image of the tooth is taken with subsequent determination of the colour by means of an intraoral camera or the like.

To be able to obtain a clear, qualitatively good and expressive image or a clear colour impression, it is advantageous to exclude all reflections or interruptive influences as much as possible.
For this purpose, numerous attachments are known which can be mounted or placed on detection units or intraoral cameras of this type. Such attachments generally have an annular contact surface, optionally of a soft material, with a round or circular aperture.
The attachment is placed against the test surface, whereby the properties of the test surface surrounded by the aperture is measured by the detection unit. The medium air is thereby found between the detection unit and the test surface.

The object of the invention is to provide an advantageous alternative to the conventional illumination of surfaces, for example, of surfaces of teeth, leather, skin, lacquer, textiles, materials or the like, whereby an attachment is proposed which is designed according to the characterizing part of claim 1. This enables, facilitates or improves a measurement or detection of surface properties, e.g. colour, roughness, reflection property, structure, etc.

By designing the conductor as a solid component or present as a solid body, greater pressure can be applied to the test surface.
By using a pad, it is attained that the attachment can be adapted to all unevennesses of the surface and can fill them as much as possible. This synergistic effect ensures that no gaps or only the smallest quality-reducing gaps remain between the test surface and the attachment.

Furthermore, it is ensured that the test surface, e.g. the dental enamel or the gums, is not damaged by the soft and optionally elastic pad.

Moreover, scattering effects during the light transmission is minimized and the light can be conducted from the light source almost free of loss to the test surface.

Moreover, an optimal, full surface illumination is obtained.

In this connection, it is advantageous if the materials of the conductor are selected according to the features of claims 2 and 3. It is thereby attained that the conductor is stable and durable and withstands the pressure exerted and that the pad can be carefully applied to the test object with a close fit.

An advantageous alternative to the design of the pad is implemented in the features of claim 5. The pad is not only soft and flexible, but can also be easily replaced.

An advantageous design of the conductor which is both inexpensive and simple to produce is described in the features of claim 6.
With this design, the pressure can be selectively applied or acted upon at certain points to a specific area of the test surface.
Moreover, the advantageous design of the attachment prevents a partial reduced illumination, shading or shade formation from occurring in the central measuring range of the test surface, in particular due to the detection unit or the camera. In this way, the test surface is illuminated essentially uniformly over the entire surface and almost free of a camera shadow or shadings.

As a result of a suitable material selection, such as advantageously described in claim 4, the shadow formation is reduced even more in that the light rays are broken toward the centre and, as a result, the dimensions of the shaded surface are additionally reduced.

An advantageous variation of the production of the attachment is noted in the features of claim 7.

To obtain a high-quality image which is uniformally illuminated, it is advantageous if the features of claim 8 are provided.

To prevent the formation of creases or interruptive air gaps between the pad and the conductor, it is advantageous if the feature of claim 9 is used. This results in an optimal adaptation of both parts of the attachment to one another.

To prevent distortions as much as possible, it is advantageous if the features of claim 10 are implemented.

For improved handling or mounting of various devices, e.g. lighting, detection units, etc., it is advantageous if the features of claim 11 are used. This is also a very simple solution from a structural point of view.

To generate diffused light, the feature of claim 12 can be advantageously provided.

To obtain optimal image quality or illumination quality, it is advantageous if the light source or the detection unit according to claims 13 and 14 are used.

The features of claim 15 represent a simple handling and effective solution from a structural point of view.

A further variation of the arrangement of light source and detection unit is described in the features of claim 16.

To obtain as sharp and high-contrast or high-detailed image as possible, it is useful or advantageous to apply the features of claim 17.

An advantageous design or use or a device in which the attachment is advantageously used is shown in claim 18.

Further advantages and designs of the invention are found in the description and the attached drawings.

The invention is schematically illustrated with reference to embodiments in the drawings and is described by way of example in the following with reference to the drawings.

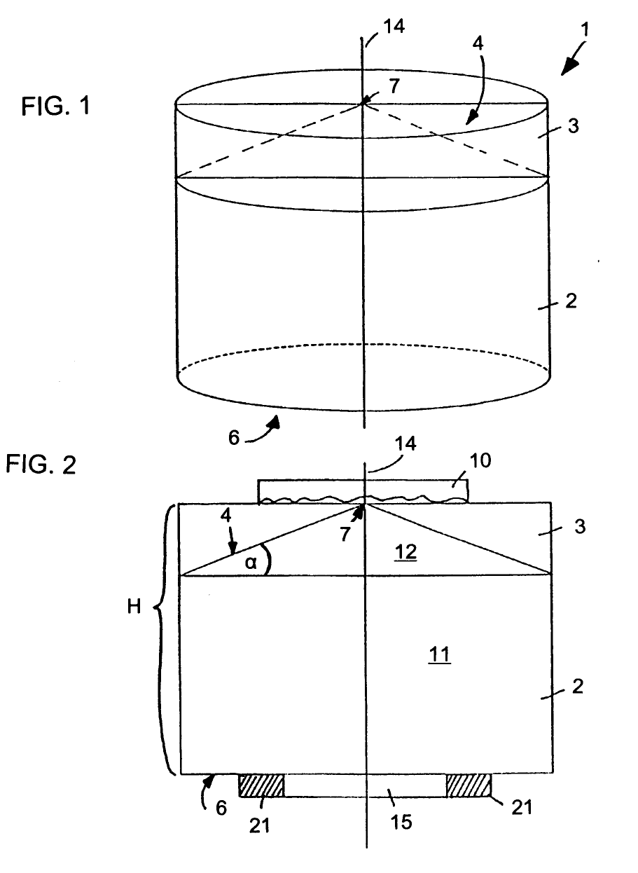

FIG. 1 shows a perspective representation of the attachment.

FIG. 2 shows a section through the attachment including lighting and detection unit.

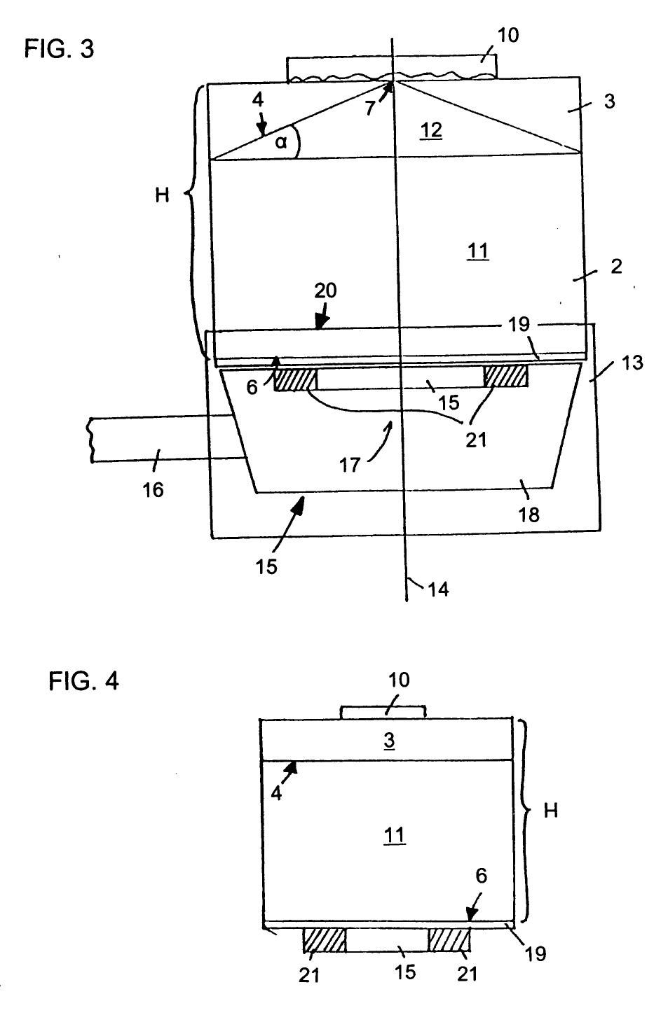

FIG. 3 shows a section through the attachment including carrier part and measuring instruments.

FIG. 4 shows a section through an alternative embodiment of an attachment.

FIG. 1 schematically shows the construction of an attachment 1 according to the invention. The position of the attachment 1 or the detection unit 15 with respect to the test surface 10 to be measured can be seen in FIG. 2.

The attachment 1 comprises a conductor 2 and a pad 3. The conductor 2 has an essentially flat light-admission surface 6 facing the light source 21 or the detection unit 15 and an optionally flat light-exit surface 4 facing the test surface 10. The conductor 2 in the form of a solid body consists of a transparent, preferably homogeneous, colourless and/or optically clear first material which can be described as hard and rigid when used as directed.
Materials which are suitable for this are, for example, glass or plastic, preferably polymethyl methacrylate, polycarbonate, polyamide, styrene acrylonitrile (SAN), polystyrene, sealing compounds or casting resins based on epoxide resin, polyurethane resin, organo-polysiloxan or the like, in particular with a ball-pressure hardness of >100 measured according to ISO 2039-1.

Advantageously the rotary-like conductor 2 has the geometric shape of a body with an upper part 11 in the form of a cylinder or a parallelepiped, in particular a rectangular parallelepiped, and a lower part 12 molded to or adjoining it in one piece in the area of the light exit or light-exit surface 6 with its base centrosymmetrically to the median axis 14, said lower part 12 being in the form of a cone, a truncated cone or a cone with a rounded tip, a pyramid, etc.

The conductor 2 may also consist of two pieces, namely of the upper part 11 and the attached lower part 12, whereby the upper part 11 and the lower part 12 preferably have an equally large and similar connecting or basal surface. The upper part 11 and the lower part 12 could be connected to one another in a material-locking manner, in particular refraction-free, in particular by gluing with a transparent, optically clear adhesive which preferably has a refractive index that lies between the refractive indices of the upper part 11 and the lower part 12.

The outer surfaces of the conductor 2 can be polished.

The flanks of the lower part 12 have a slope angle α of maximum 60°, in particular of maximum 53°, preferably of maximum 45°. As a result of this inclination, a shadowing, in particular by the detection unit 15, of the central area about the median axis 14 is prevented and a distortion is kept as low as possible when the tip 7 of the conductor 2 is raised from the surface of the test object 10 to be measured.

A transparent, preferably homogeneous, colourless and/or optically clear pad 3 is attached to the conductor 2 or to the light-exit surface 4 of the conductor 2, said pad adjoining the light-exit surface 4 in a form-locking and optionally material-locking manner.

This pad 3 may be in the form of a solid body and consists in this case of a transparent, preferably homogeneous, colourless and/or optically clear second material which has a hardness that is less than the first material, i.e. which is softer than the first material. In particular, a ductile, pliant, flexible and/or elastic material, preferably having a shore hardness of <40, measured according to the A-scale or having a penetration of a 150 g-heavy needle by 0.1 mm, is used for this purpose, for example, silicone or silicone derivatives or polyurethanes. The pad 3 is advantageously soft in a gel-like manner, however, it does not dissolve.

Alternatively, the pad 3 can be made as a transparent, preferably colourless and/or optically clear hollow body whose preferably very thin casing is formed from a ductile, flexible and/or elastic material or a foil, e.g. of silicone or a silicone derivative or polyurethane, and which is filled with a transparent, preferably homogeneous, colourless and/or optically clear medium, e.g. a liquid or a gel, in particular water, a sodium chloride solution, etc.

The pad 3 advantageously has a recess or formation complementary to the lower part 12 of the conductor 2 for accommodating the conductor 2 or the lower part 12. This prevents a crease formation or deformation when the conductor 2 is joined with the pad 3 and interruptive air pockets are more or less excluded. A recess of this type is obtained by molding or casting via a pattern or mold or by casting or molding directly on or to the conductor 2. In this way, the pad 3 is adapted to or connected to the conductor 2 in a form-locking or material-locking manner.

Due to the elastic formation of the casing in a construction of the pad 3 as a filled hollow body, the lower part 12 can penetrate into the pad 3 and the casing adjoins the light-exit surface 4 of the lower part 12 in a tight, air-pocket free and sealed manner.

On the one hand, the pad 3 can be connected with the conductor 2 by direct molding or gluing, in particular in a refraction-free manner, with a transparent, optically clear adhesive which preferably has a refractive index that lies between the refractive indices of the upper part 11 and the lower part 12, whereby it can be sufficient if it is not glued over the entire surface but only at a few points, in particular four points in the peripheral area. It can also suffice that the pad 3 is merely pressed onto the lower part 12 and the adhesion is great enough that the pad 3 remains in its position.

To obtain optimal results, it is advantageous if the tip 7 of the lower part 12 or of the conductor 2 ends essentially in a common plane with the preferably continuous surface of the pad 3 facing the test object 10. The tip 7 can thereby also project through a small hole, in particular on the median axis 14, of the pad 3 in direction of the test surface 10. Distortions and blurredness is prevented as much as or as extensively as possible.

When in use, the attachment 1 with the pad 3 is placed against the test surface 10 to be measured and sufficient pressure applied.
The pad 3 should be adapted to the shape or structure or profile of the surface as much as possible. Air pockets between test object 10 and pad 3 should be excluded, if possible, as they might affect the quality of the image.

After measuring, the pad 3 remains dependent on the material, either in its shape and does not adapt to the new surface until the next measurement, or it is sufficiently elastic that it returns to a neutral shape or to its initial position.

With a pad 3 designed as a filled hollow body, the tip 7 of the lower part presses on the pad 3, as a result of which the liquid or the gel is displaced and the tip 7 of the test surface 10 is not only separated by the two positions of the casing of the pad 3 in the extreme case. However, due to the very slight thickness of the casing, this distance to the test surface can be disregarded and does not affect the measurement results.

The conductor 2 and/or the pad 3 can be designed as a disposable item for a single use or made washable or sterilizable and thus be reusable. It is also possible to just exchange the pad 3 and to place a new pad 3, e.g. fastened with a contact adhesive, onto the conductor 2 prior to each measurement.

It is advantageous if the refractive index of the conductor 2 is greater than the refractive index of the pad 3. As a result, light rays emanating from the light source 21 are broken when passing from the conductor 2 to the pad 3 in direction of the median axis 14, i.e. toward the centre. This reduces a shadowing of the central area.

When the pad 3 is formed as a filled hollow body, the light rays are also broken toward the centre by the filling with a medium having a refractive index that is less than that of the conductor 2.

The light rays of the light source 21 pass either directly from the light source 21 through the conductor 2 or they are held at the lateral walls of the conductor 2, in particular the upper part 11, by total reflection inside the conductor 2. An optionally one-sided, inward pointing reflective coating of the surfaces of the conductor 2, in particular the upper part 11, is also possible.

As can be seen in FIG. 3, a carrier part 13 can be fastened or clamped in the area of the light-admission surface 6 of the conductor 2. One possibility for attaching and fixing is the formation of a notch or groove 20 in the upper part 11 of the conductor 2 which preferably extends about the entire periphery of the conductor 2. A plurality of devices can be fastened or accommodated on or in this carrier part 13, e.g. a diffusing lens 19, the light source 21, the detection unit 15, in particular an intraoral camera, a handle 16, etc.

The diffusing lens 19 is advantageously provided on or in front of the light-admission surface 6 of the conductor 2 between the light source 21 and the light-admission surface 6 and can be glued or mounted either on the light-admission surface 6 or it is fastened to or in the carrier part 13.

The diffusing lens 19 may be a prism foil or an optical lighting film. The light of the light source 21 is scattered through it and diffused.

The light source 21 is advantageously arranged in the centre or in a circular form about the median axis 14 of the conductor or in front of the light-admission surface 6. The light source 21 may consist of several individual light sources, in particular light diodes (LEDs), or it can be formed by a luminous disk or surface.

The detection unit 15 is provided on or in front of the light-admission surface 6. Detection unit 15 refers to an image-recording and/or image-generating or image-transmitting device, in particular a video camera, e.g. an intraoral camera or a CCD chip. The detection unit 15 is advantageously fastened in the middle or centrosymmetrically to the median axis 14 or in the area of the carrier part 13. An advantageous arrangement is that the detection unit 15 is surrounded in a circular manner by the light source 21. This arrangement is often used in commercial intraoral cameras to obtain optimal illumination.

A handle 16 can be fastened to the carrier part 13, whereby the handle 16 is either securely connected to the carrier part 13 or can be easily mounted and taken off or can be clipped on. The light source 21 and/or the detection unit 15 can be integrated in the top of the handle 16, if possible in the handle 16, namely in particular in the top of the handle 18 inserted in the carrier part 13 or mounted on it. In the event that a light source 21 is mounted on the attachment 1, a recess 17 can be formed in the carrier part 13 through which the conductor 2 is in an optically conducting connection with the detection unit 15 and/or the light source 21.

It is also possible that the detection unit 15 and/or the light source 21 are external devices which are in an operative or optically conducting connection with the conductor 2 via a reflector system or optically conducting system arranged inside the handle 16. Optical conductors, e.g. glass fiber lines, which conduct the light from an external light source 21 into the attachment 1 or the conductor 2 are also feasible.

The light of the light source 21 used is preferably white light, however, UV light and/or light of other selected wavelengths or wavebands can also be used.

To take the focal length of the detection unit 15, in particular the intraoral camera, into consideration, it is useful and advantageous that the height H of the conductor 2 which is measured from the light-admission surface 6 to the tip 7 of the lower part 12 corresponds to the focal length of the detection unit 15.

A further embodiment of the invention according to FIG. 4 provides that the angle α of the lower part 12 is 0°, i.e. that the conductor 2 has the form of the upper part 11 or is reduced to the form of the upper part 11. The pad 3 is installed or fastened to the flat light-exit surface 4 of the conductor 2 in a form-locking or material-locking manner. The height of the attachment 1, measured from the light-admission surface 6 of the conductor to the surface of the pad 3 facing away from the conductor 2 should correspond to the focal length of the detection unit 15. Above all, this embodiment is advantageously used when using a diffusing lens 19.

1-18. (canceled)

19. An optical attachment for a device having a light source, the attachment comprising:
a solid, transparent, colorless, and/or optically clear conductor formed with a light-admission surface and a light-exit surface;
a transparent colorless and/or optically clear cushion pad adjoining said light-exit surface of said conductor in a form-locking relationship.

20. The attachment according to claim 19, wherein said conductor is a homogeneous body and said light-admission surface is substantially flat.

21. The attachment according to claim 19, wherein said cushion pad is a homogeneous body.

22. The attachment according to claim 19, wherein said cushion pad is connected at said light-exit surface of said conductor in a material-locking manner.

23. The attachment according to claim 19 configured for attachment to an illuminating device for illuminating uneven surfaces or to a detection unit with a light source.

24. The attachment according to claim 23 configured for illuminating tooth surfaces, and wherein said cushion pad is formed for placement on the tooth surfaces.

25. The attachment according to claim 23, wherein the detection unit is an intraoral camera.

26. The attachment according to claim 19, wherein said conductor is formed of a rigid and hard first material.

27. The attachment according to claim 26, wherein said first material is a glass or plastic material selected from the group consisting of polymethyl methacrylate, polycarbonate, polyamide, styrene acryInitrile, polystyrene, sealing compounds or casting resins based on epoxide resin, polyurethane resin, and organo-polysiloxane.

28. The attachment according to claim 26, wherein said first material has a ball-pressure hardness of >100 measured according to ISO 2039-1.

29. The attachment according to claim 19, wherein said cushion pad is a solid body formed of a ductile, flexible and/or elastic second material.

30. The attachment according to claim 19, wherein said second material is silicone or a silicone derivative or polyurethane, with a shore-A-hardness of <40.

31. The attachment according to claim 19, wherein said first material has a higher refractive index than said second material.

32. The attachment according to claim 19, wherein said pad is a hollow body having a thin casing of a ductile, flexible and/or elastic material filled with a transparent medium.

33. The attachment according to claim 32, wherein said material of said thin casing is silicone or a silicone derivative or polyurethane, and said transparent medium is a colorless and/or optically clear liquid or a gel.

34. The attachment according to claim 19, wherein said conductor has a geometric form of a body with an upper part in the form of a cylinder or a parallelepiped, and optionally a lower part molded on or adjoining said upper part with its base centrosymetrically in one piece in a region of said light exit, and wherein said lower part is in the form of a cone, a truncated cone or a cone with a rounded tip.

35. The attachment according to claim 19, wherein said conductor is formed in two pieces consisting of an upper part and a lower part, connected to one another in a material-locking manner.

36. The attachment according to claim 35, wherein said upper part and said lower part are glued to one another with a transparent, optically clear adhesive having a refractive index between a refractive index of said upper part and a refractive index of said lower part.

37. The attachment according to claim 35, wherein flanks or a sheathing of said lower part or said light-exit surface have a slope angle relative to an inclination of said light-admission surface of no more than 60°.

38. The attachment according to claim 37, wherein said slope angle has a maximum of 53°.

39. The attachment according to claim 37, wherein said slope angle has a maximum of 45°.

40. The attachment according to claim 35, wherein said cushion pad is formed with a recess complementary to said lower part for accommodating said conductor or said lower part.

41. The attachment according to claim 35, wherein said lower part has a tip substantially ending in a plane with the surface of said cushion pad facing away from said light-exit surface of said conductor.

42. The attachment according to claim 19, which further comprises a carrier part for mounting or handling or fastening components attached to said conductor.

43. The attachment according to claim 42, wherein said conductor is formed with a notch or groove extending in circumferential direction.

44. The attachment according to claim 19, which comprises a diffusing lens fastened to said carrier part or to said conductor is at or in front of said light-admission surface.

45. The attachment according to claim 44, wherein said diffusing lens is disposed between said light-admission surface and the light source.

46. The attachment according to claim 19, wherein the light source is fastened at or in front of the light-admission surface of said conductor.

47. The attachment according to claim 46, wherein the light source is fastened centrally about a median axis of said conductor.

48. The attachment according to claim 19 in combination with a detection unit selected from the group consisting of an image-recording device, an image generating device, and a transmitting device, wherein said detection unit is fastened to or in front of said light-admission surface of said conductor.

49. The combination according to claim 48, wherein said detection unit is a video camera or a CCD chip fastened to or in front of and centrally or centro-symmetrically to a median axis of a carrier part attached to said conductor.

50. The attachment according to claim 42, which comprises a handle to be connected to said carrier part, and wherein said carrier part has a recess formed therein through which said conductor is connected in an optically conducting manner with at least one of the detection unit and the light source.

51. In combination, the attachment according to claim 19, a light source and a detection unit, wherein said light source and said detection unit are integrated in a handle.

52. The combination according to claim 51, wherein said light source and said detection unit are integrated in a top of said handle in a vicinity of a carrier part.

53. The combination according to claim 51, wherein one of said light source and said detection unit are disposed outside of said attachment in an external component and are optically connected with said conductor via at least one light transmitting unit provided in said handle or in the top of said handle.

54. The combination according to claim 53, wherein said light transmitting unit is a mirror or a glass fiber line.

55. The attachment according to claim 19, wherein a height of said conductor, measured from said light-admission surface to a tip of a lower part thereof, corresponds to a focal length of the detection unit.

56. The attachment according to claim 19, wherein a height of said conductor, measured from said light-admission surface to a surface of said cushion pad facing away from said conductor, corresponds to a focal length of the detection unit.

57. In combination with an illuminating device, an attachment device according to claim 19.

58. In combination with a device for detecting or recording surface features, an attachment device according to claim 19.

59. In combination with an illuminating device for detecting surface features selected from the group consisting of colors and structures, an attachment device according to claim 19.

60. In combination with an intraoral camera, an attachment device according to claim 19.
